(19) United States
(12) Patent Application Publication
(10) Pub. No.: US 2016/0073340 A1
(43) Pub. Date: Mar. 10, 2016

(54) ENHANCEMENTS FOR WIFI MULTIMEDIA EXTENSIONS

(71) Applicant: QUALCOMM Incorporated, San Diego, CA (US)

(72) Inventors: Qi Xue, San Diego, CA (US); Peerapol Tinnakornsrisuphap, San Diego, CA (US)

(21) Appl. No.: 14/481,059

(22) Filed: Sep. 9, 2014

(51) Int. Cl. H04W 52/02; H04W 72/04; H04W 52/38

(52) U.S. Cl. CPC H04W 52/0212; H04W 52/386; H04W 72/042

(57) ABSTRACT

A method of operating a station (STA) in a communications network is disclosed. A set of access categories of the STA that are enabled for unscheduled automatic power save delivery (U-APSD) are identified. Specifically, each access category in the set of access categories is associated with one or more user priority values. A lowest-priority access category is determined among the set of access categories. Specifically, the lowest-priority access category is associated with the lowest user priority value among the set of access categories. A trigger frame associated with the lowest-priority access category is then transmitted to an access point (AP) to initiate a first unscheduled service period with the AP.

### TECHNICAL FIELD

The present embodiments relate generally to wireless networks, and specifically to extending the idle duration of a communications device in a wireless network.

### BACKGROUND OF RELATED ART

A Wi-Fi network may be formed by one or more access points (APs) that provide a wireless communication channel or link with a number of client devices or stations (STAs). Each AP, which may correspond to a Basic Service Set (BSS), periodically broadcasts beacon frames to enable any STAs within wireless range of the AP to establish and/or maintain a communication link with the Wi-Fi network. The beacon frames, which may include a traffic indication map (TIM) and/or a delivery traffic indication message (DTIM) indicating whether the AP has queued downlink data for the STAs, are typically broadcast according to a target beacon transmission time (TBTT) schedule. A TIM is typically broadcast with each beacon frame, whereas a DTIM may be broadcast at a frequency specified by a DTIM interval (e.g., with every four beacon frames).

The IEEE 802.11e specification defines a number of quality-of-service (QoS) enhancements for prioritizing the flow of data traffic in a network. Specifically, the IEEE 802.11e specification defines an Enhanced Distributed Channel Access (EDCA) framework which maps 8 user priority (UP) values to 4 access categories (ACs). For example, “background” data (AC_BK) maps to UP values 1 and 2, “best effort” data (AC_BE) maps to UP values 0 and 3, “video” data (AC_VI) maps to UP values 4 and 5, and “voice” data (AC_VO) maps to UP values 6 and 7. In addition, the IEEE 802.11e specification also supports an Unscheduled Automatic Power Save Delivery (U-APSD) mechanism which enables a STA to retrieve downlink (DL) data from an AP using “trigger” frames. The user of trigger frames allows the STA to initiate an unscheduled service period with the AP at any time (e.g., without waiting for a beacon frame and/or TIM information).

However, while U-APSD is supported by IEEE 802.11e compatible devices, the functionality is typically disabled by default for all ACs because the IEEE standard does not fully define a method of coordinating legacy power save (PS) and U-APSD modes of operation between different ACs. Furthermore, APs which currently implement the IEEE 802.11e standard typically only release DL data with UP values equal to and/or higher in priority than the UP value of the trigger frame sent by the STA. As a result, AC mismatches between uplink (UL) trigger frames and DL data packets may cause low-priority DL data (such as AC_BE packets) to experience long delays and/or get dropped from the AP queue. In addition, AC mismatches may also cause the STA to wake up more frequently from a low-power idle state in order to retrieve the lower-priority data packets.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A method of operating a station (STA) in a communications network is disclosed. For example, the communications network may be based on an IEEE 802.11e standard. The STA identifies a set of access categories that are enabled for unscheduled automatic power save delivery (U-APSD). Specifically, each access category in the set of access categories is associated with one or more user priority values. A lowest-priority access category is determined from among the set of access categories. Specifically, the lowest-priority access category is associated with the lowest user priority value. The STA then sends a trigger frame associated with the lowest-priority access category to an access point (AP) to initiate a first unscheduled service period with the AP.

For some embodiments, the set of access categories that are enabled for U-APSD may include all access categories of the STA. For example, the lowest-priority access category may correspond to a best-effort access category. Accordingly, the STA may transmit a trigger frame associated with the best-effort access category upon receiving a beacon frame from the AP and determine, based on a traffic indication message included with the beacon frame, that downlink data is available for the STA.

For other embodiments, the set of access categories enabled for U-APSD may include a subset of a plurality of access categories of the STA. In other words, U-APSD may be disabled for at least one access category of the plurality of access categories. If at least one of the access categories is not enabled for U-APSD, the STA may subsequently transmit a power save (PS) poll request message to the AP upon completion of the first unscheduled service period, for example, to retrieve data associated with any access category that is not enabled for U-APSD.

A trigger timer may be associated with each access category in the set of access categories that are enabled for U-APSD. Specifically, each trigger timer may count down for a duration of a trigger interval. The STA may determine that the trigger timer associated with at least one access category in the set of access categories has timed out. For some embodiments, the STA may transmit the trigger frame associated with the lowest-priority access category upon determining that the trigger timer associated with any of the access categories has timed out. Further, the STA may reset the trigger timer for each access category in the set of access categories upon completion of the first unscheduled service period.

Further, the STA may initiate a second unscheduled service period to transmit one or more uplink data frames to the AP. Specifically, each of the one or more uplink data frames may be associated with a first access category of the set of access categories enabled for U-APSD. Upon completion of the second unscheduled service period, the STA may reset the trigger timer for each access category in the set of access categories associated with a user priority value that is equal to or higher than a user priority value of the first access category.

In other embodiments, a STA may receive a plurality of data frames from an AP and determine that the plurality of data frames are bundled into a single real-time transport protocol (RTP) data packet. The STA may then adjust a trigger interval based on the determination. Specifically, the trigger interval may correspond with a duration between successive transmissions of U-APSD trigger frames from the STA to the AP. Specifically, the trigger interval may be adjusted based on a number of data frames that are bundled into a single RTP data packet. For example, the STA may determine an increase in the number of data frames that are bundled into a single RTP packet and extend the trigger interval in proportion to the increase. On the other hand, the STA may determine a decrease in the number of data frames that are bundled into a single RTP data packet and shorten the trigger interval in proportion to the decrease.

By attempting to retrieve any and all available downlink data from an AP each time a STA is awake, the method of operation disclosed herein may allow the STA to remain in an idle or power-save state for longer durations. Moreover, dynamically adjusting a STA's trigger interval may help to further reduce the frequency with which the STA wakes up from the idle state to retrieve buffered data from the AP.

### BRIEF DESCRIPTION OF THE DRAWINGS

The present embodiments are illustrated by way of example and are not intended to be limited by the figures of the accompanying drawings, where:

FIG. 1 shows a block diagram of a WLAN system within which the present embodiments may be implemented.

FIG. 2 shows a block diagram of a wireless station (STA) in accordance with some embodiments.

FIGS. 3A-3B are exemplary timing diagrams illustrating AC-synchronized exchanges of data between an access point (AP) and a STA, in accordance with some embodiments.

FIG. 4 is an exemplary timing diagram illustrating an AC-synchronized exchange of data between an AP and a STA, in accordance with other embodiments.

FIG. 5 is an exemplary timing diagram illustrating a dynamic trigger timer adjustment based on packet bundling, in accordance with some embodiments.

FIG. 6 shows an illustrative flow chart depicting an exemplary operation for synchronizing data retrieval for U-APSD enabled ACs, in accordance with some embodiments.

FIG. 7 shows an illustrative flow chart depicting an AC-synchronized data retrieval operation to be performed when a STA is in an idle state, wherein U-APSD is enabled for each AC of the STA.

FIG. 8 shows an illustrative flow chart depicting an AC-synchronized data retrieval operation to be performed when a STA is in an idle state, wherein U-APSD is disabled for at least one AC of the STA.

FIG. 9 shows an illustrative flow chart depicting an AC-synchronized data retrieval operation to be performed when a STA is in an active state.

### DETAILED DESCRIPTION

The present embodiments are described below in the context of data retrieval in WLAN systems for simplicity only. It is to be understood that the present embodiments are equally applicable to data retrieval in other wireless networks (e.g., cellular networks, pico networks, femto networks, satellite networks, etc.), as well as for systems using signals of one or more wired standards or protocols (e.g., Ethernet and/or HomePlug/PLC standards). As used herein, the terms “WLAN” and “Wi-Fi” may include communications governed by the IEEE 802.11 family of standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including an AP and a plurality of STAs, the present embodiments are equally applicable to other WLAN systems including, for example, WLANs including a plurality of APs, peer-to-peer (or Independent Basic Service Set) systems, Wi-Fi Direct systems, and/or Hotspots. In addition, although described below in terms of four particular access categories (ACs) defined by the IEEE 802.11e specification, the present embodiments may be applied to any communications systems that classifies data according to different priority levels (e.g., for QoS purposes).

In the following description, numerous specific details are set forth such as examples of specific components, circuits, and processes to provide a thorough understanding of the present disclosure. The term “coupled” as used herein means connected directly to or connected through one or more intervening components or circuits. The term “trigger frame” or “U-APSD trigger” as used herein may refer to any data frame transmitted by a STA to an AP that triggers an unscheduled service period with the AP. It should be noted, however, that a trigger frame may or may not include uplink data. For example, a trigger frame may correspond to a QoS Null frame transmitted by the STA to the AP for the purpose of retrieving downlink data from the AP. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The present embodiments are not to be construed as limited to specific examples described herein but rather to include within their scope all embodiments defined by the appended claims.

The IEEE 802.11e specification defines an Enhanced Distributed Channel Access (EDCA) framework which maps 8 user priority (UP) values to 4 access categories (ACs). For example, “background” data (AC_BK) maps to UP values 1 and 2, “best effort” data (AC_BE) maps to UP values 0 and 3, “video” data (AC_VI) maps to UP values 4 and 5, and “voice” data (AC_VO) maps to UP values 6 and 7. Each STA may include a different transmit queue for each AC, and the transmit queues are to independently content for medium access. For example, each transmit queue may “listen” to a shared communications medium to determine when the medium is idle (e.g., using a “carrier sense” technique). More specifically, only when a particular transmit queue detects that the medium has been continuously idle for a corresponding Arbitration InterFrame Space (AIFS) duration may that transmit queue attempt to transmit data on the medium.

Data may be selected for transmission over a shared medium according to priority levels, for example, so that higher priority data (e.g., voice data) may be allocated higher transmission priorities than lower priority data (e.g., best-effort data such as emails). More specifically, data may be classified based on a traffic identifier (TID) and a destination address (DA). The DA indicates to which STA or AP the data is to be transmitted. The TID indicates the priority level of the data, and may thus be mapped to a corresponding AC. Furthermore, data of different priority levels may be assigned different AIFS durations so that higher priority data is more likely to win a given medium access contention period than lower priority data. For example, the AIFS number (AIFSN) assigned to voice data is lower (e.g., corresponding with a shorter duration) than the AIFSN assigned to best-effort data.

To prevent multiple transmit queues from accessing the medium at the same time, each queue may select a random “back-off” number during a contention window following an AIFS duration. Thus, at the end of the AIFS duration, a contention window (CW) begins during which each transmit queue waits for a period determined by its back-off number before it attempts to transmit data on the medium. The queue that selects the lowest back-off number has the shortest back-off period, and therefore “wins” the medium access contention operation. The winning transmit queue may be granted access to the shared wireless medium for a period of time commonly referred to as the transmit opportunity (TXOP), during which the winning transmit queue may transmit data over the shared wireless medium.

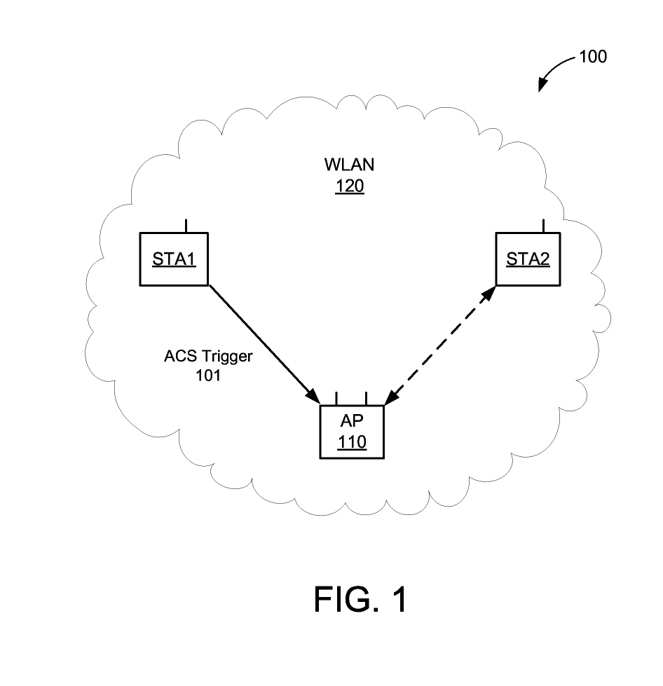

FIG. 1 shows a block diagram of a WLAN system 100 within which the present embodiments may be implemented. The system is shown to include 2 wireless stations STA1 and STA2, a wireless access point (AP) 110, and a wireless local area network (WLAN) 120. The WLAN 120 may be formed by a plurality of Wi-Fi APs that may operate according to the IEEE 802.11 family of standards (or according to other suitable wireless protocols). Thus, although only one AP 110 is shown in FIG. 1 for simplicity, it is to be understood that WLAN 120 may be formed by any number of APs. The AP 110 is assigned a unique MAC address that is programmed therein by, for example, the manufacturer of the AP. Similarly, each of STA1 and STA2 is also assigned a unique MAC address.

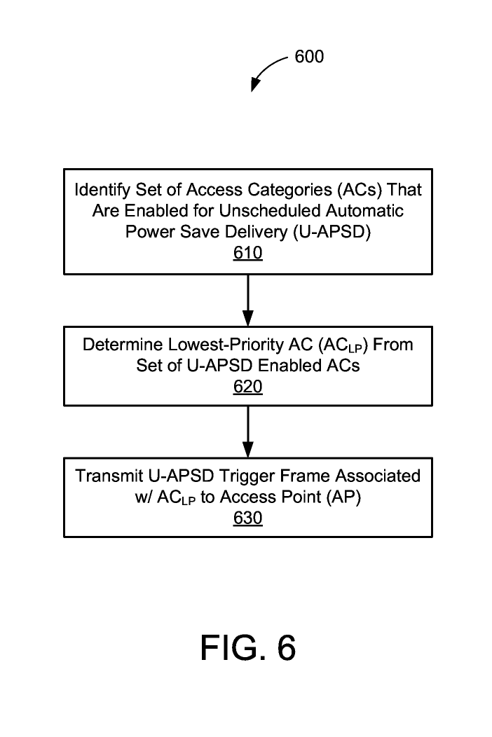

The stations STA1 and STA2 may be any suitable Wi-Fi enabled wireless devices including, for example, cell phone, personal digital assistants (PDAs), tablet devices, laptop computers, or the like. For at least some embodiments, STA1 and STA2 may include a transceiver, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 6-9.

The AP 110 may be any suitable device that allows one or more wireless devices to connect to a network (e.g., a LAN, WAN, MAN, and/or the Internet) via AP 110 using Wi-Fi, Bluetooth, or any other suitable wireless communication protocols. For at least one embodiment, AP 110 may include a transceiver, a network interface, one or more processing resources, and one or more memory resources. The memory resources may include a non-transitory computer-readable medium (e.g., one or more nonvolatile memory elements, such as EPROM, EEPROM, Flash memory, a hard drive, etc.) that store instructions for performing operations described below with respect to FIGS. 6-9.

To conserve power, each of the stations STA1 and/or STA2 may enter a low-power idle state when the station has no data to send to (and/or receive from) the AP 110. In order to maintain a connection with the WLAN 120, a station may periodically wake up from the idle state to receive beacon frames from the AP 110. More specifically, the beacon frames may include a traffic indication map (TIM) and/or a delivery traffic indication message (DTIM) indicating whether the AP 110 has queued downlink (DL) data for a particular station. If the DTIM bit is asserted for a particular station, that station may then contend for medium access in order to retrieve the DL data from the AP 110.

The IEEE 802.11e specification further defines an Unscheduled Automatic Power Save Delivery (U-APSD) mechanism which enables a station to initiate an unscheduled service period with the AP 110 at any time (e.g., without waiting for a beacon frame and/or TIM information) by sending a U-APSD trigger frame to the AP 110. Specifically, the IEEE 802.11e specification defines two types of U-APSD enabled ACs: “delivery-enabled” ACs and “trigger-enabled” ACs. If a particular AC is delivery-enabled, the AP 110 may deliver buffered data for that AC during an unscheduled service period. If a particular AC is trigger-enabled, data frames of subtype QoS Data and QoS Null for that AC may be used to trigger an unscheduled service period with the AP 110. For simplicity, a “U-APSD enabled AC” or an “AC that is enabled for U-APSD” herein refers to an AC that is both trigger-enabled and delivery-enabled.

Thus, a station having one or more U-APSD enabled ACs may proactively check for buffered DL data at the AP 110 by transmitting a trigger frame associated with (e.g., identified by) a particular U-APSD enabled AC. It should be noted, however, that under typical implementations of the IEEE 802.11e specification, the AP 110 responds to U-APSD triggers by releasing buffered data having UP values equal to or greater than that of the trigger frame. For example, if a station sends an AC_VI trigger frame to the AP 110, the AP 110 may release buffered voice and/or video data to the requesting station, while continuing to retain any available best effort data (and background data) in its corresponding transmit queue. As described above, this may cause low-priority DL data to experience long delays and/or get dropped altogether from the transmit queue. It should be noted that background (AC_BK) data is typically bulk data that requires very high (e.g., maximum) throughput to transmit. However, AC_BK data is not time-sensitive, and therefore may remain in the transmit queue(s) for longer durations without becoming stale.

To address the issue above, for some embodiments, a station may synchronize its data retrieval operations for all U-APSD enabled ACs. For example, with respect to FIG. 1, STA1 may transmit an AC-synchronized (ACS) trigger frame 101 to the AP 110 each time STA1 proactively attempts to retrieve DL data from the AP 110. For some embodiments, the ACS trigger frame 101 may correspond with a QoS Null frame associated with a lowest-priority AC of STA1. As used herein, the term “lowest-priority AC” refers to a particular U-APSD enabled AC that has the lowest user priority among all of the U-APSD enabled ACs for a particular station. For example, if all access categories (e.g., AC_VO, AC_VI, AC_BE, and AC_BK) of STA1 are U-APSD enabled, the best-effort access category (AC_BE) may represent the lowest-priority AC (e.g., UP=0). Accordingly, the STA1 may transmit an AC_BE trigger frame (e.g., a QoS Null frame that is associated with the best-effort access category) as the ACS trigger frame 101.

On the other hand, if only the voice and video access categories (e.g., AC_VO and AC_VI) of STA1 are U-APSD enabled, the STA1 may transmit an AC_VI trigger frame (e.g., a QoS Null frame that is associated with the video access category) as the ACS trigger frame 101. For some embodiments, the STA1 may transmit a power save (PS) poll request frame to the AP 101 immediately following a service period triggered by a U-APSD trigger that is not associated with AC_BE to attempt to retrieve any low-priority data from the AP 110. In addition, the PS poll request frame may cause the AP 110 to deliver buffered data for ACs that are not enabled for U-APSD.

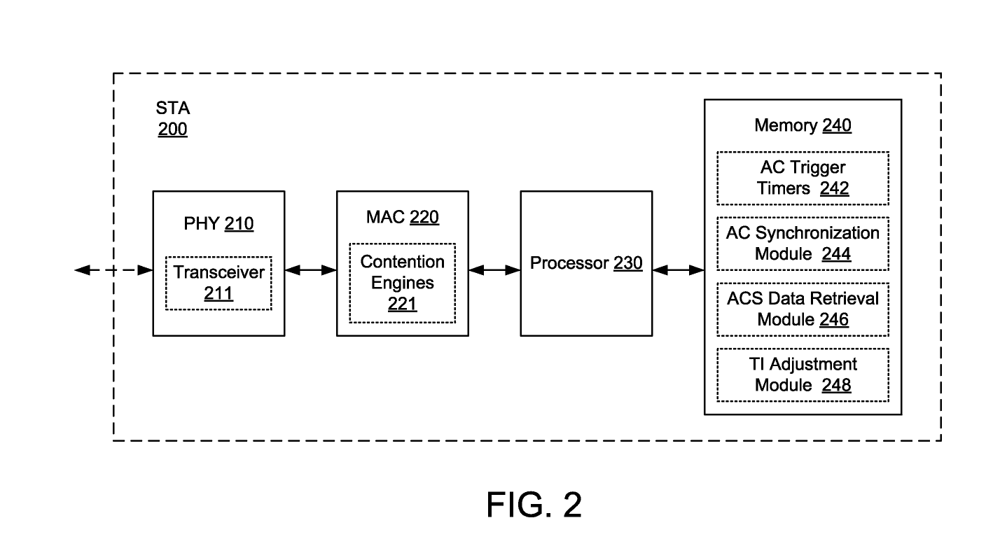

FIG. 2 shows a block diagram of a wireless STA 200 in accordance with some embodiments. Specifically, the STA 200 may be embodiment of at least one of the stations STA1 and/or STA2 of FIG. 1. The STA 200 may include a PHY device 210 including at least a WLAN transceiver 211, a MAC device 220 including a number of contention engines 221, a processor 230, and a memory 240. The transceiver 211 may be used to transmit signals to and receive signals from an AP (e.g., AP 110 of FIG. 1) and/or other STAs, and to scan the surrounding environment to detect and identify nearby APs (e.g., APs within range of STA 200). For purposes of discussion herein, MAC device 220 is shown in FIG. 2 as being coupled between PHY device 210 and processor 230. For actual embodiments, PHY device 210, MAC device 220, processor 230, and/or memory 240 may be connected together using one or more buses (not shown for simplicity).

The contention engines 221 may contend for access to a shared wireless communications medium, and may also store packets for transmission over the shared medium. The STA 200 may include one or more contention engines 221 for each of a plurality of different ACs. For other embodiments, the contention engines 221 may be separate from MAC device 220. Still further, for some embodiments, the contention engines 221 may be implemented as one or more software modules (e.g., stored in memory 240 or stored in memory provided within MAC device 220) containing instructions that, when executed by processor 230, perform the functions of contention engines 221.

Memory 240 may include a plurality of AC trigger timers 242 that may cause the STA 200 to initiate an unscheduled service period with the AP. For example, two AC trigger timers 242 may be assigned to each access category of the STA 200: an active trigger timer and an idle trigger timer. Each idle trigger timers counts down for a given trigger interval or duration when the STA 200 is in an idle state. If an idle trigger timer times out (e.g., while the STA 200 is in an idle state), the STA 200 is woken up from the idle state to initiate an unscheduled service period with the AP. Each active trigger timer counts down for a given trigger interval or duration (which may be the same or different than the trigger intervals associated with the idle trigger timers) when the STA 200 is in an active state. If an active trigger timer times out (e.g., while the STA 200 is in an active state), the STA 200 remains awake to at least initiate an (or another) unscheduled service period with the AP.

Memory 240 may also include a non-transitory computer-readable medium (e.g., one or more nonvolatile memory elements, such as EPROM, EEPROM, Flash memory, a hard drive, and so on) that can store the following software modules:
an AC synchronization module 244 to identify and synchronize U-APSD enabled ACs of the STA 200;
an AC-synchronized (ACS) data retrieval module 246 to retrieve buffered data from the AP for at least the U-APSD enabled ACs; and
a trigger interval (TI) adjustment module 248 to dynamically adjust the trigger interval associated with one or more ACs based on packet bundling by the AP.
   Each software module includes instructions that, when executed by processor 230, causes STA 200 to perform the corresponding functions. The non-transitory computer-readable medium of memory 240 thus includes instructions for performing all or a portion of the operations described below with respect to FIGS. 6-9.

Processor 230, which is shown in the example of FIG. 2 as coupled to PHY device 210 and transceiver 211, to MAC device 220 and contention engines 221, and to memory 240, may be any suitable processor capable of executing scripts or instructions of one or more software programs stored in STA 200 (e.g., within memory 240). For example, processor 230 may execute the AC synchronization module 244 to identify and synchronize any U-APSD enabled ACs of the STA 200. Processor 230 may also execute the ACS data retrieval module 246 to retrieve any buffered data form the AP for at least the U-APSD enabled ACs. Further, processor 230 may execute the TI adjustment module 248 to dynamically adjust the trigger interval associated with one or more ACs based on packet bundling by the AP.

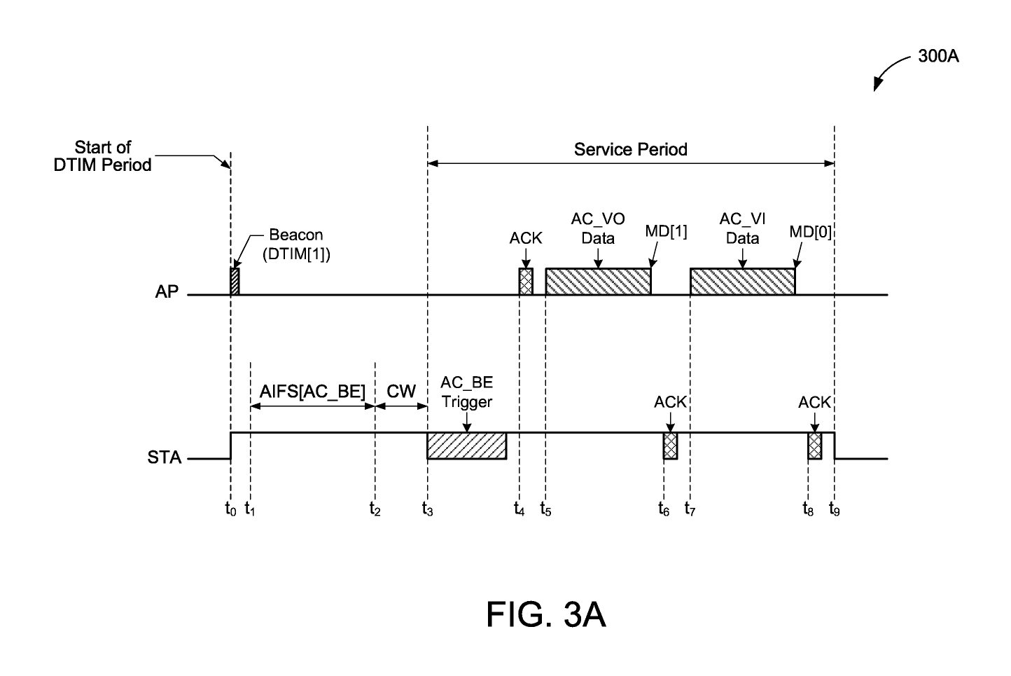

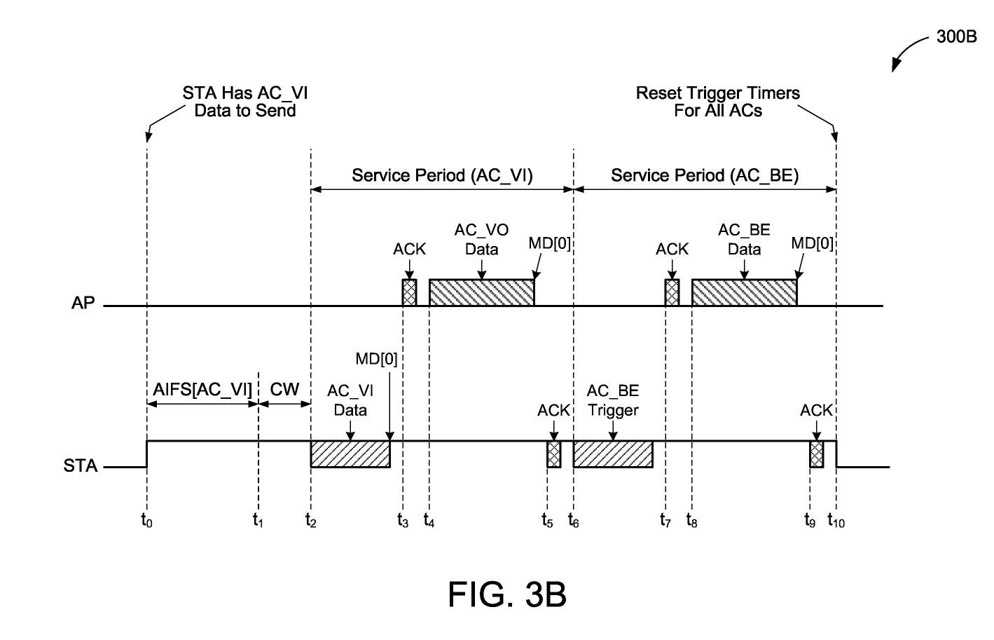

FIGS. 3A-3B are exemplary timing diagrams 300A and 300B illustrating AC-synchronized exchanges of data between an AP and a STA, in accordance with some embodiments. In particular, FIG. 3A illustrates an AC-synchronized data retrieval operation that may be performed by a STA when the STA is initially in a low-power idle state (e.g., prior to time t₀). FIG. 3B illustrates an AC-synchronized data retrieval operation that may be performed by a STA when the STA is already in an active state (e.g., at time t₆). With respect to FIGS. 3A-3B, it is assumed that all ACs of the STA are enabled for U-APSD.

With reference to FIG. 3A, a DTIM period starts at time t₀. The STA wakes up from an idle state at the start of the DTIM period to receive a beacon frame from the AP (e.g., at time t₀). A DTIM bit provided with the beacon frame is asserted (DTIM[1]), indicating that DL data is available for that particular STA. For some embodiments, the beacon frame may further indicate that voice (AC_VO) and video (AC_VI) data are buffered for the STA.

The STA then contends for medium access in order to retrieve the DL data from the AP. Specifically, although AC_VO and AC_VI data are available for the STA, the STA nonetheless uses an AC_BE trigger frame to retrieve the DL data from the AP. As described above, AC_BE represents the lowest-priority access category when all ACs are U-APSD enabled. Thus, an AC_BE trigger frame may be used to retrieve the buffered AC_VO and AC_VI data in addition to any lower priority (e.g., AC_BE) data that may be or become available during a service period. Accordingly, when contending for medium access, the STA waits an AIFS duration associated with a best-effort access category (e.g., from time t₁-t₂) before counting down a random backoff interval. The random backoff interval may fall within a contention window (CW) that is particular to the best-effort access category (e.g., from time t₂-t₃).

At time t₃, the STA wins access to the shared medium and transmits an AC-synchronized (e.g., AC_BE) trigger frame to the AP, which initiates an unscheduled service period (e.g., from time t₃-t₆) with the AP. For some embodiments, the AC_BE trigger frame may correspond to a QoS Null frame that is identified or otherwise associated with the best-effort access category. For other embodiments (e.g., if the STA has best-effort data to be transmitted to the AP), the STA may transmit a QoS Data frame to the AP as the AC_BE trigger frame. The AP responds to the AC_BE trigger by sending an acknowledgement (ACK) frame back to the STA (e.g., at time t₄), followed by the buffered DL data.

It should be noted that, during the service period, the AP may transmit data frames that are associated with any access category of equal and/or higher priority than the access category of the received trigger frame. For example, the AP may transmit AC_VO, AC_VI, and/or AC_BE data frames to the STA in response to an AC_BE trigger frame. It should be noted that background (AC_BK) data is typically bulk data that requires maximum throughput to transmit. However, AC_BK data is not time-sensitive, and therefore may remain in the transmit queue(s) for longer durations.

The AP sends an AC_VO data frame to the STA (e.g., at time t₅) and waits for an acknowledgement from the STA. A “more data” bit may be asserted (MD[1]) with the AC_VO data frame, indicating that the AP has additional data to send to the STA. The STA responds to the AC_VO data frame by sending an ACK frame back to the AP (e.g., at time t₆) confirming receipt of the AC_VO data frame. The AP then sends an AC_VI data frame to the STA (e.g., at time t₇) and again waits for an acknowledgement from the STA. A more data bit may be deasserted (MD[0]) in the AC_VI data frame, indicating that the AP has no additional data to send to the STA. The STA responds to the AC_VI data frame by sending an ACK frame to the AP (e.g., at time t₈) and subsequently returns to a low-power idle state (e.g., at time t₉), thus ending the service period.

With reference to FIG. 3B, the STA wakes up at time t₀ because it has uplink (UL) data to send to the AP. Specifically, the UL data may correspond to QoS Data identified or otherwise associated with a video (AC_VI) access category. The STA then contends for medium access in order to transmit the UL data to the AP. For example, the STA waits an AIFS duration associated with a video access category (e.g., from time t₀-t₁) before counting down a random backoff interval. The random backoff interval may fall within a contention window (CW) that is particular to the video access category (e.g., from t₁-t₂).

At time t₂, the STA wins access to the shared medium and transmits an AC_VI data frame to the AP, which initiates an unscheduled service period (e.g., from time t₂-t₆) with the AP. A more data bit may be deasserted (MD[0]) in the AC_VI data frame, indicating that the STA has no additional data to send to the AP. The AP responds to the AC_VI data frame by sending an ACK frame back to the STA (e.g., at time t₃) confirming receipt of the AC_VI frame. The AP then transmits a buffered AC_VO data frame to the STA (e.g., at time t₄). A more data bit may be deasserted (MD[0]) in the AC_VO data frame, indicating that the AP has no additional data to send to the STA for the current service period. The STA responds to the AC_VO data frame by sending an ACK frame to the AP (e.g., at time t₅), thus ending the current service period.

It should be noted that the AP may have additional buffered data for the STA (e.g., at time t₆) which the AP is unable to deliver due to the priority level associated with the current service period. For example, the AP may have additional best-effort (AC_BE) data buffered for the STA. However, because the current service period (e.g., from time t₂-t₆) is associated with the video access category (e.g., triggered by an AC_VI data frame), the AP may be unable to deliver the lower-priority AC_BE data during this service period. Thus, the STA may attempt to retrieve any additional (e.g., lower-priority) data from the AP using an AC-synchronized trigger frame.

For example, the STA may send an AC_BE trigger frame to the AP following the current service period (e.g., at time t₆) to initiate another service period (e.g., from time t₆-t₁₀) with the AP. As described above, the AC_BE trigger frame may correspond to a QoS Null frame that is identified or otherwise associated with the best-effort access category. For some embodiments, the AC_BE trigger frame may be transmitted immediately (e.g., within a Short InterFrame Space duration) following the transmission of the ACK frame (e.g., at time t₅). This may prevent other stations from having an opportunity to contend for and/or access the shared medium.

The AP responds to the AC_BE trigger frame by sending an ACK frame back to the STA (e.g., at time t₇), followed by a buffered AC_BE data frame (e.g., at time t₈). A more data bit may be deasserted (MD[0]) in the AC_BE data frame, indicating that the AP has no additional data to send to the STA. The STA responds to the AC_BE data frame by sending an ACK frame to the AP (e.g., at time t₉) and subsequently returns to a low-power idle state (e.g., at time t₁₀), thus ending the service period. It should be noted that the AP may send higher-priority (e.g., AC_VI and/or AC_VO) data during the service period associated with the best-effort access category (e.g., from t₆-t₁₀) should any higher-priority data become available. For some embodiments, the STA may reset a trigger timer associated with each of the access categories (e.g., AC_VI, AC_VO, and AC_BE) upon completion of the AC_BE service period.

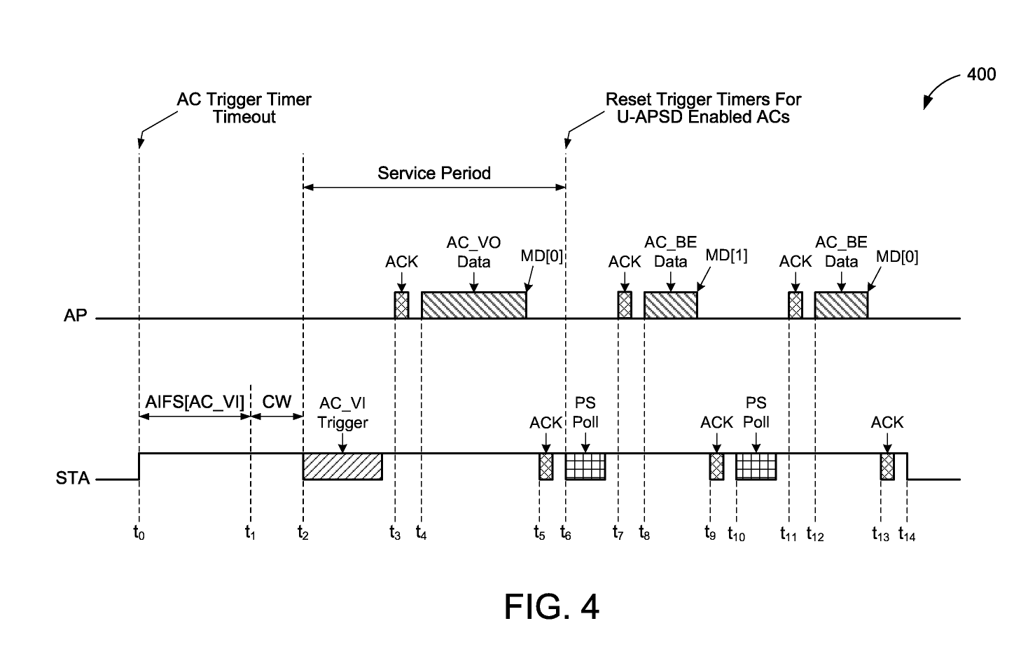

FIG. 4 is an exemplary timing diagram 400 illustrating an AC-synchronized exchange of data between an AP and a STA, in accordance with other embodiments. With respect to FIG. 4, it is assumed that only the voice and video access categories (e.g., AC_VO and AC_VI) are enabled for U-APSD. Accordingly, AC_VI represents the lowest-priority access category of this particular STA.

An AC trigger timeout causes the STA to wake up at time t₀ and contend for medium access. Specifically, the AC trigger timeout may correspond to the end of a trigger interval associated with an idle trigger timer for one of the U-APSD enabled access categories (e.g., AC_VO or AC_VI). For some embodiments, the STA uses a trigger frame associated with the lowest-priority access category (e.g., AC_VI) regardless of the trigger timer that times out. For example, the AC trigger timeout (e.g., at time t₀) may correspond with an AC_VO trigger timer or an AC_VI trigger timer. Accordingly, when contending for medium access, the STA waits an AIFS duration associated with a video access category (e.g., from time t₀-t₁) before counting down a random backoff interval. The random backoff interval may fall within a contention window (CW) that is particular to the video access category (e.g., from time t₁-t₂).

At time t₂, the STA wins access to the shared medium and transmits an AC-synchronized (e.g., AC_VI) trigger frame to the AP, which initiates an unscheduled service period (e.g., from time t₂-t₆) with the AP. For some embodiments, the AC_VI trigger frame may correspond to a QoS Null frame that is identified or otherwise associated with the video access category. For other embodiments (e.g., if the STA has video data to be transmitted to the AP), the STA may transmit a QoS data frame to the AP as the AC_VI trigger frame. The AP responds to the AC_VI trigger frame by sending an ACK frame back to the STA (e.g., at time t₃). As described above, during the service period, the AP may transmit data frames that are associated with any access category of equal and/or higher priority than the access category of the received trigger frame. For example, the AP may transmit AC_VO and/or AC_VI data frames to the STA in response to an AC_VI trigger frame.

The AP sends an AC_VO data frame to the STA (e.g., at time t₄) and waits for an acknowledgement from the STA. A more data bit may be deasserted (MD[0]) in the AC_VO data frame, indicating that the AP has no additional data to send to the STA. The STA responds to the AC_VO data frame by sending an ACK frame back to the AP (e.g., at time t₅), thus ending the service period. For some embodiments, the STA may reset a trigger timer associated with each of the U-APSD enabled access categories (e.g., AC_VI and AC_VO) upon completion of the unscheduled service period. It should be noted that the AP may have additional buffered data (e.g., at time t₆) which the AP is unable to deliver to the STA during the service period. For example the additional buffered data may belong to a lower-priority AC and or an AC that is not U-APSD enabled (specifically, the AC may not be delivery-enabled). Thus, the STA may attempt to retrieve any additional (e.g., lower-priority) data from the AP using a PS polling mechanism (e.g., as defined by the 802.11 standard).

For example, the STA may send a PS poll request frame to the AP following the unscheduled service period (e.g., at time t₆). The AP responds to the PS poll request frame by sending an ACK frame back to the STA (e.g., at time t₇) followed by an AC_BE data frame (e.g., at time t₈). A more data bit may be asserted (MD[1]) with the AC_BE data frame, indicating that the AP has additional data to send to the STA. The STA responds to the AC_BE data frame by sending an ACK frame back to the AP (e.g., at time t₉) followed by another PS poll request frame (e.g., at time t₁₀). The AP responds to the second PS poll request frame by sending an ACK frame back to the STA (e.g., at time t₁₁) followed by another AC_BE data frame (e.g., at time t₁₂). A more data bit may be deasserted (MD[0]) with the second AC_BE data frame, indicating that the AP has no additional data to send to the STA. The STA responds to the second AC_BE data frame by sending an ACK frame back to the AP (e.g., at time t₁₃) and subsequently returns to a low-power idle state (e.g., at time t₁₄).

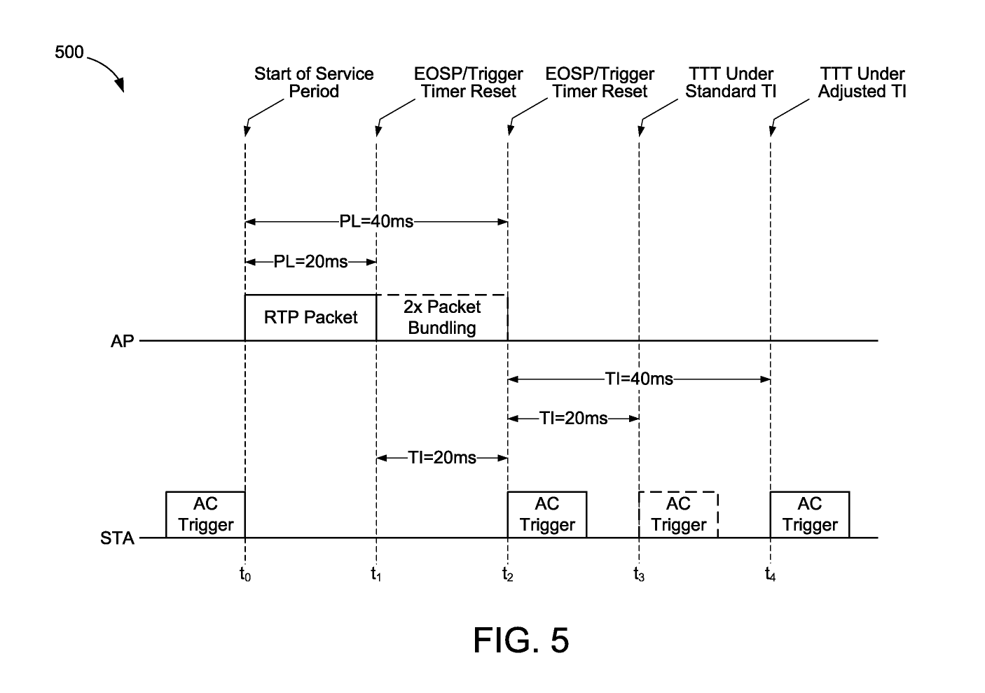

FIG. 5 is an exemplary timing diagram 500 illustrating a dynamic trigger timer adjustment based on packet bundling, in accordance with some embodiments. In some embodiments, an AP may aggregate multiple data frames in a single upper-layer data packet. This technique is commonly known as “codec bundling.” For example, the AP may “bundle” a plurality of audio frames in each Real-time Transport Protocol (RTP) data packet sent to the STA. An AP may dynamically perform codec bundling based on channel and/or network conditions. For example, the AP may bundle data packets when the resulting end-to-end delay is within a given budget and/or a receiving STA is at a low modulation and coding scheme (MCS) or experiences congestion (e.g., based on a packet error rate and/or buffer size).

Packet bundling may result in longer service period durations. For example, with reference to FIG. 5, an AP may transmit an RTP packet to a STA in response to an AC trigger frame (e.g., at time t₀). Without packet bundling, the RTP packet length may be 20 ms (e.g., PL=20 ms). A corresponding U-APSD trigger interval of the STA may be 20 ms (e.g., TI=20 ms). Thus, upon completion of a service period (e.g., at time t₁), the STA may wait a duration of 20 ms before checking the AP for more data (e.g., at time t₂). However, if the AP bundles two data frames into a single RTP packet, the length of the corresponding RTP packet is doubled (e.g., PL=40 ms). If the trigger interval remains unchanged (e.g., TI=20 ms), the STA will wake up to check for more data 20 ms upon completion of the service period (e.g., from time t₂-t₃). As a result, the STA may spend twice as long in the active state (e.g., from time t₀-t₂) as it spends in the idle state (e.g., from time t₂-t₃).

For some embodiments, the STA may dynamically adjust its U-APSD trigger interval(s) based on packet bundling by the AP. For example, when the AP increases the number of packets bundled into a single RTP packet, the STA may increase the duration of a corresponding trigger interval. Similarly, when the AP decreases the number of packets bundled into a single RTP packet, the STA may decrease the duration of the corresponding trigger interval. For some embodiments, the change in duration of the trigger interval may be proportional to the increase and/or decrease in packet bundling. For example, if the AP doubles the number of packets that are bundled into a single RTP packet, the STA may double the duration of the corresponding trigger interval.

With reference to FIG. 5, if the AP increases the packet length of an RTP packet form 20 ms to 40 ms, the STA may correspondingly increase its trigger interval from 20 ms to 40 ms. Accordingly, the STA may transmit a subsequent AC trigger frame 40 ms after the completion of the service period (e.g., from time t₂-t₄). This allows the STA to maintain substantially the same proportion of idle/active times as before (e.g., without packet bundling).

FIG. 6 shows an illustrative flow chart depicting an exemplary operation 600 for synchronizing data retrieval for U-APSD enabled ACs, in accordance with some embodiments. For example, with reference to FIG. 1, the AC-synchronization operation 600 may be implemented by any of the wireless stations STA1 and/or STA2 in the wireless network 120. Specifically, a STA may first identify a set of ACs that are enabled for U-APSD (610). For example, the STA may enable U-APSD for a particular AC via a QoS Info field in an association (and/or reassociation) request with an AP. Alternatively, an Add Traffic Stream (ADDTS) function may be used to enable U-APSD for a particular AC after associating with the AP. As described above, an AC may be trigger-enabled (e.g., the STA may send a QoS frame associated with this AC to initiate an unscheduled service period with the AP) and/or delivery-enabled (e.g., the STA may receive QoS data from an AP during an unscheduled service period). For some embodiments, the identified set of ACs may include only ACs that are both trigger-enabled and delivery-enabled.

The STA then determines a lowest-priority AC from the set of U-APSD enabled ACs (620). As described above, the lowest-priority AC corresponds to a particular U-APSD enabled AC that has the lowest user priority among all of the U-APSD enabled ACs of the STA. For example, if all access categories (e.g., AC_VO, AC_VI, AC_BE, and AC_BK) of the STA are U-APSD enabled, the lowest-priority AC may correspond to the best-effort access category (e.g., AC_BE). If only the voice and video access categories are U-APSD enabled, the lowest-priority AC may correspond to the video access category (e.g., AC_VI). For some embodiments, the lowest-priority AC may correspond to the lowest-priority AC that is both trigger-enabled and delivery-enabled.

Finally, the STA may transmit a U-APSD trigger frame associated with the lowest-priority AC to the AP (630). More specifically, the STA may synchronize its data retrieval operation for all U-APSD enabled ACs, for example, by transmitting a trigger frame associated with the lowest-priority AC (e.g., an AC-synchronized trigger frame) to the AP each time the STA becomes active (e.g., each time the AP proactively attempts to retrieve DL data from the AP). For example, the trigger frame may correspond with a QoS Data frame (e.g., if the STA has UL data to send to the AP) or a QoS Null frame. As described above, the AP may respond to an AC-synchronized trigger frame by transmitting data frames to the STA that are associated with any access category of equal and/or higher priority than the access category of the received trigger frame (e.g., the lowest-priority AC).

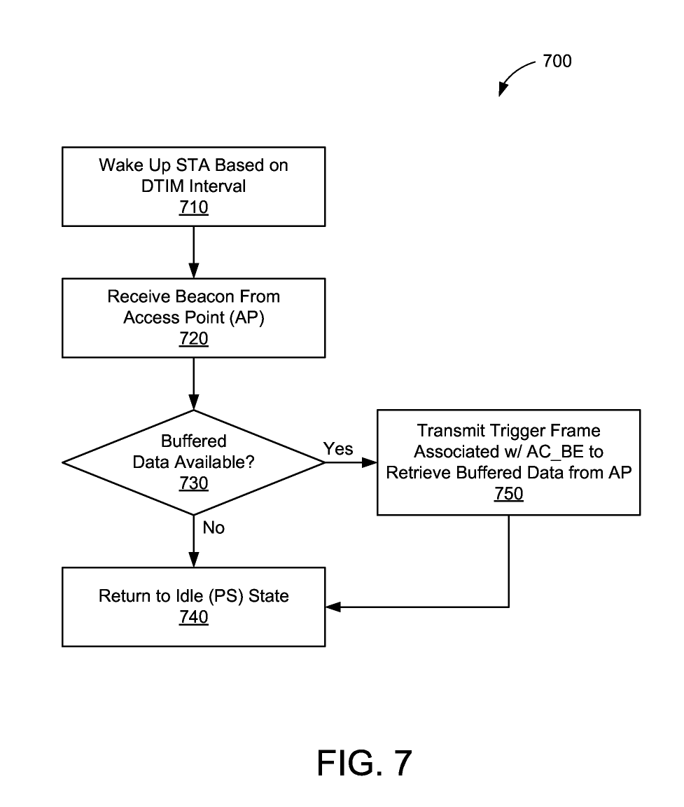

FIG. 7 shows an illustrative flow chart depicting an AC-synchronized data retrieval operation 700 to be performed when a STA is in an idle state, wherein U-APSD is enabled for each AC of the STA. The STA first wakes up from an idle state based on a DTIM interval (710). As described above, a DTIM interval corresponds with a frequency (e.g., of beacon intervals) with which the STA may wake up from an idle state to exchange data with the AP.

The STA then receives a beacon frame from the AP (720) and determines whether buffered data is available for the STA (730). For example, a DTIM bit may be provided with the beacon frame indicating whether DL data is available for each STA in the wireless network. More specifically, the DTIM bit may be asserted if the AP has buffered data for the STA. For some embodiments, the beacon frame may further indicate the particular types (e.g., access categories) of data available for the STA.

If no buffered data is available (730), the STA may return to a low-power idle state (740). Otherwise, the STA may transmit a trigger frame associated with the best-effort access category (AC_BE) to retrieve the buffered data from the AP (750). As described above, AC_BE represents the lowest-priority access category when all ACs are U-APSD enabled. Thus, because all access categories of the STA are U-APSD enabled, the AP may transmit any and/or all buffered data to the STA in response to the AC_BE trigger frame. At the end of the service period triggered by the AC_BE trigger frame, the STA may return to the low-power idle state (750).

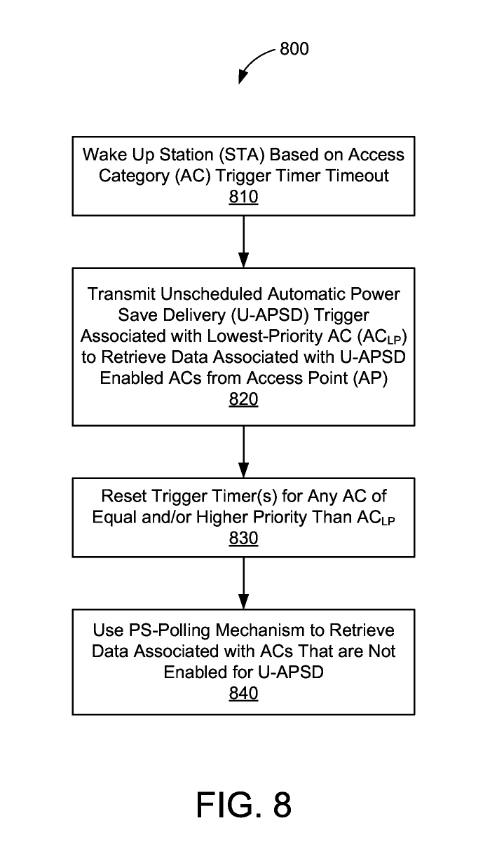

FIG. 8 shows an illustrative flow chart depicting an AC-synchronized data retrieval operation 800 to be performed when a STA is in an idle state, wherein U-APSD is disabled for at least one AC of the STA. The STA first wakes up in response to an AC trigger timeout (810). For example, an AC trigger timeout may correspond to the end of a trigger interval associated with an idle trigger timer for one of the U-APSD enabled ACs. More specifically, the idle trigger timer may count down for the duration of the given trigger interval when the STA is in an idle state. When an idle trigger timer (e.g., associated with any U-APSD enabled AC) times out, the STA is woken up from the sleep state to initiate an unscheduled service period with an AP.

Upon waking up from the idle state, the STA may transmit a U-APSD trigger frame associated with the lowest-priority AC to retrieve buffered data associated with any U-APSD enabled ACs from the AP (820). As described above, the lowest-priority AC corresponds to a particular U-APSD enabled AC that has the lowest user priority among all of the U-APSD enabled ACs of the STA. For example, if only the voice and video access categories are U-APSD enabled, the lowest-priority AC may correspond to the video access category (e.g., AC_VI). It should be noted, however, that the STA sends a trigger frame for the lowest-priority AC regardless of the trigger timer that times out. Thus, the STA may transmit an AC_VI trigger frame (e.g., where AC_VI is the lowest-priority AC) in response to an AC_VO trigger timeout.

The AP may respond to the lowest-priority trigger frame by transmitting data to the STA for any U-APSD enabled ACs of equal and/or higher priority than that of lowest-priority AC. For example, the AP may respond to an AC_VI trigger frame by transmitting any buffered AC_VO and/or AC_VI data to the STA. At the end of the service period, the STA may reset the trigger timer(s) for any AC of equal and/or higher priority than the lowest-priority AC (830). It should be noted, however, that any buffered data belonging to an AC that is not U-APSD enabled may not be delivered to the STA during the unscheduled service period.

Finally, the STA may use a PS-polling mechanism to retrieve data associated with any ACs that are not enabled for U-APSD (840). For example, the STA may send one or more PS poll request frames to the AP upon completion of the unscheduled service period to retrieve any additional buffered data from the AP. More specifically, the STA may continue to poll the AP until all remaining buffered data has been retrieved.

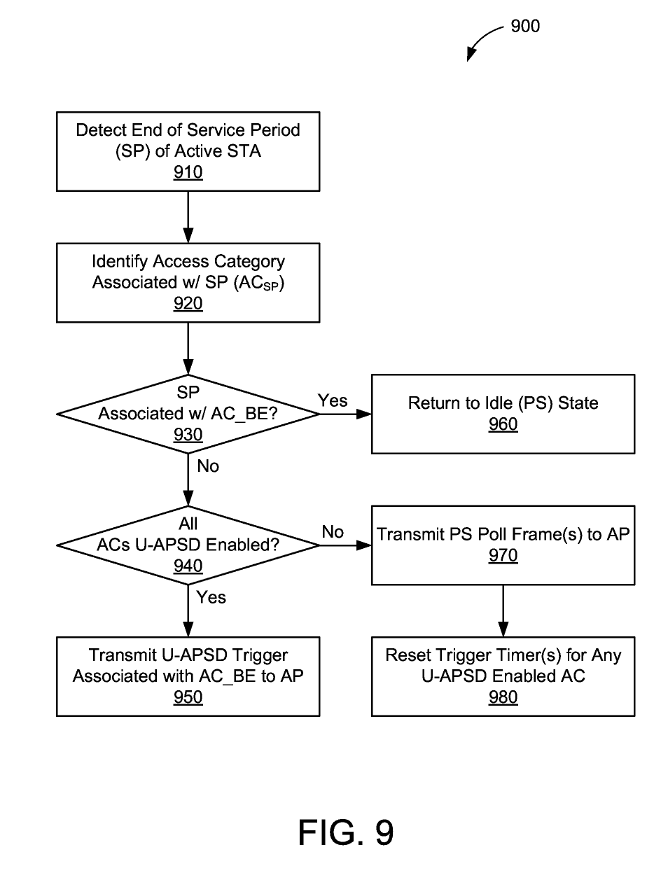

FIG. 9 shows an illustrative flow chart depicting an AC-synchronized data retrieval operation 900 to be performed when a STA is in an active state. The active STA may first detect an end of service period (910). For example, an AP may deassert the more data bit in the final data frame sent to the STA, which indicates that the AP has no additional buffered data for the STA. Deassertion of the more data bit may also signal the end of the current service period.

The STA may then identify an AC associated with the current service period (920). The AC associated with the current service period may correspond to the access category for the trigger frame sent by the STA to initiate the current service period (e.g., the service period that just ended). If the current service period is associated with the best-effort access category (930), it is likely that the AP has delivered all buffered data to the STA. Thus, the STA may subsequently return to a low-power idle state (960).

If the current service period is not associated with the best-effort access category (930), and all access categories of the STA are U-APSD enabled (940), the STA may transmit a U-APSD trigger frame associated with the best-effort access category to the AP (950) upon completion of the current service period. As described above, AC_BE represents the lowest-priority AC when all ACs are U-APSD enabled. Thus, an AC_BE trigger frame may be used to retrieve buffered data for any and/or all ACs of the STA. For some embodiments, the STA may transmit the AC_BE trigger frame immediately following completion of the current service period (e.g., without having to contend for the medium)

If the current service period is not associated with the best-effort access category (930), and at least one access category of the STA is disabled for U-APSD (940), the STA may transmit one or more PS poll request frames (970) upon completion of the current service period. As described above, the PS poll request frames may be used to retrieve any additional buffered data from the AP. For some embodiments, the STA may transmit the PS poll request frames immediately following the end of the current service period (e.g., without waiting for a DTIM period). After the STA has finished retrieving all available data from the AP, the STA may reset one or more trigger timers for any U-APSD enabled ACs (980).

In the foregoing specification, the present embodiments have been described with reference to specific exemplary embodiments thereof. It will, however, be evident that various modifications and changes may be made thereto without departing from the broader scope of the disclosure as set forth in the appended claims. For example, the method steps depicted in the flow charts of FIGS. 6-9 may be performed in other suitable orders, multiple steps may be combined into a single step, and/or some steps may be omitted. The specification and drawings are, accordingly, to be regarded in an illustrative sense rather than a restrictive sense.

What is claimed is:

1. A method of operating a station (STA) in a communications network, the method comprising:
identifying a set of access categories of the STA that are enabled for unscheduled automatic power save delivery (U-APSD), wherein each access category in the set of access categories is associated with one or more user priority values;
determining a lowest-priority access category from the set of access categories, wherein the lowest-priority access category is associated with a lowest user priority value; and
transmitting a trigger frame associated with the lowest-priority access category to an access point (AP) to initiate a first unscheduled service period with the AP.

2. The method of claim 1, wherein the set of access categories enabled for U-APSD includes all access categories of the STA, and wherein the lowest-priority access category corresponds to a best-effort access category.

3. The method of claim 2, wherein transmitting the trigger frame associated with the lowest-priority access category comprises:
receiving a beacon frame from the AP;
determining, based on a traffic indication message included with the beacon frame, that downlink data is available for the STA; and
transmitting a trigger frame associated with the best-effort access category to the AP to retrieve the downlink data.

4. The method of claim 1, wherein the set of access categories enabled for U-APSD comprises a subset of a plurality of access categories of the STA, and wherein U-APSD is disabled for at least one access category of the plurality of access categories.

5. The method of claim 1, further comprising:
transmitting a power save (PS) poll request message to the AP upon completion of the first unscheduled service period.

6. The method of claim 1, further comprising:
associating a trigger timer with each access category in the set of access categories enabled for U-APSD.

7. The method of claim 6, further comprising:
dynamically adjusting the trigger interval based, at least in part, on a bundling of downlink data packets by the AP.

8. The method of claim 6, wherein transmitting the trigger frame associated with the lowest-priority access category comprises:
determining that the trigger timer associated with at least one access category in the set of access categories has timed out; and
upon determining that the trigger timer associated with the at least one access category has timed out, transmitting the trigger frame associated with the lowest-priority access category.

9. The method of claim 8, further comprising:
resetting the trigger timer for each access category in the set of access categories upon completion of the first unscheduled service period.

10. The method of claim 6, further comprising:
initiating a second unscheduled service period to transmit one or more uplink data frames to the AP, wherein each of the one or more uplink data frames is associated with a first access category of the set of access categories enabled for U-APSD; and
upon completion of the second unscheduled service period, resetting the trigger timer for each access category in the set of access categories associated with a priority value that is equal to or higher than a user priority value of the first access category.

11. The method of claim 1, wherein the communications network is based on an IEEE 802.11e standard.

12. A method of operating a station (STA) in a communications network, the method comprising:
receiving data frames from an access point (AP), wherein a plurality of the data frames are bundled by the AP into a single real-time transport protocol (RTP) data packet; and
adjusting a trigger interval for the STA based at least in part on the data frames from the AP in the single RTP packet, wherein the trigger interval corresponds with a duration between successive transmissions of unscheduled automatic power save delivery (U-APSD) trigger frames to the AP.

13. The method of claim 12, wherein adjusting the trigger interval comprises:
adjusting the trigger interval based on a number of data frames from the AP in the single RTP data packet.

14. The method of claim 13, further comprising:
determining a change in the number of data frames received from the AP in the single RTP data packet; and
modifying the trigger interval in proportion to the change.

15. The method of claim 14, wherein modifying the trigger interval comprises:
extending the trigger interval in proportion to an increase in the number of data frames received from the AP in the single RTP packet.

16. The method of claim 14, wherein modifying the trigger interval comprises:
shortening the trigger interval in proportion to a decrease in the number of data frames received from the AP in the single RTP packet.

17. A computing device, comprising:
means for identifying a set of access categories of the computing device that are enabled for unscheduled automatic power save delivery (U-APSD), wherein each access category in the set of access categories is associated with one or more user priority values;
means for determining a lowest-priority access category from the set of access categories, wherein the lowest-priority access category is associated with a lowest user priority value; and
means for transmitting a trigger frame associated with the lowest-priority access category to an access point (AP) to initiate a first unscheduled service period with the AP.

18. The computing device of claim 17, wherein the set of access categories enabled for U-APSD includes all access categories of the computing device, and wherein the lowest-priority access category corresponds to a best-effort access category.

19. The computing device of claim 18, wherein the means for transmitting the trigger frame associated with the lowest-priority access category is to:
receive a beacon frame from the AP;
determine, based on a traffic indication message included with the beacon frame, that downlink data is available for the computing device; and
transmit a trigger frame associated with the best-effort access category to the AP to retrieve the downlink data.

20. The computing device of claim 17, wherein the set of access categories enabled for U-APSD comprises a subset of a plurality of access categories of the computing device, and wherein U-APSD is disabled for at least one access category of the plurality of access categories.

21. The computing device of claim 17, further comprising:
means for transmitting a power save (PS) poll request message to the AP upon completion of the first unscheduled service period.

22. The computing device of claim 17, further comprising:
means for associating a trigger timer with each access category in the set of access categories enabled for U-APSD.

23. The computing device of claim 22, further comprising:
means for dynamically adjusting the trigger interval based, at least in part, on a bundling of downlink data packets by the AP.

24. The computing device of claim 22, wherein the means for transmitting the trigger frame associated with the lowest-priority access category is to:
determine that the trigger timer associated with at least one access category in the set of access categories has timed out; and
transmit the trigger frame associated with the lowest-priority access category upon determining that the trigger timer associated with the at least one access category has timed out.

25. The computing device of claim 24, further comprising:
means for resetting the trigger timer for each access category in the set of access categories upon completion of the first unscheduled service period.

26. The computing device of claim 22, further comprising:
means for initiating a second unscheduled service period to transmit one or more uplink data frames to the AP, wherein each of the one or more uplink data frames is associated with a first access category of the set of access categories enabled for U-APSD; and
means for resetting the trigger timer for each access category in the set of access categories associated with a priority value that is equal to or higher than a user priority value of the first access category upon completion of the second unscheduled service period.

27. The computing device of claim 17, wherein the computing device communicates with the AP via a wireless local area network protocol.

28. A computing device, comprising:
means for receiving data frames from an access point (AP), wherein a plurality of the data frames are bundled by the AP into a single real-time transport protocol (RTP) data packet; and
means for adjusting a trigger interval for the computing device based at least in part on the data frames from the AP in the single RTP packet, wherein the trigger interval corresponds with a duration between successive transmissions of unscheduled automatic power save delivery (U-APSD) trigger frames to the AP.

29. The computing device of claim 28, wherein the means for adjusting the trigger interval comprises:
means for adjusting the trigger interval based on a number of data frames from the AP in the single RTP data packet.

30. The computing device of claim 29, further comprising:
means for determining a change in the number of data frames received from the AP in the single RTP data packet; and
means for modifying the trigger interval in proportion to the change.
